(19) United States
(12) Patent Application Publication
(10) Pub. No.: US 2018/0115096 A1
(43) Pub. Date: Apr. 26, 2018

(54) CONTACT PART AND PRESS-FIT TERMINAL

(71) Applicant: DAI-ICHI SEIKO CO., LTD., Kyoto-shi (JP)

(72) Inventors: Takayoshi Endo, Shizuoka-shi (JP); Jun Mukunoki, Shizuoka-shi (JP); Takuya Takeda, Shizuoka-shi (JP); Shota Tanaka, Shizuoka-shi (JP)

(21) Appl. No.: 15/785,089

(22) Filed: Oct. 16, 2017

(30) Foreign Application Priority Data
Oct. 26, 2016 (JP) 2016-209904

(51) Int. Cl. H01R 12/70

(52) U.S. Cl. CPC H01R 12/7064

(57) ABSTRACT

A contact part, which is connected to a pillar-like pin of a press-fit terminal and which has spring characteristics, includes: a first retention contact piece that comes into contact with an inner surface of a through hole in a circuit board, which is the connection target of the press-fit terminal, and that includes a first retention part to be retained on a lower edge of the through hole in the circuit board; and a lower coupling part that supports the first retention contact piece.

### CROSS-REFERENCE TO RELATED APPLICATION

This application claims the benefit of Japanese Patent Application No. 2016-209904, filed on Oct. 26, 2016, the entire disclosure of which is incorporated by reference herein.

### FIELD

This application relates to a contact part and a press-fit terminal.

### BACKGROUND

A press-fit terminal may be operation when, for example, inserted into a through hole formed in a circuit board (see Patent Literatures 1 and 2, for example). Such a press-fit terminal includes a rod-like pin and a contact part attached to the pin. When the contact part comes into contact with an electrode in the through hole, electrical connection is established between the press-fit terminal and the through hole.

Patent Literature 1 Japanese Patent No. 5445605

Patent Literature 2 Japanese Patent No. 5831509

### SUMMARY

Such a press-fit terminal is needed to have a retention force for a board, and in some cases, an even greater retention force may be needed.

The present disclosure has been created under the foregoing circumstances, and an objective of the disclosure is to provide a contact part and a press-fit terminal that can enhance the retention force of a press-fit terminal for its connection target.

To achieve the above-described objective, a contact part according to a first aspect of the present disclosure is connected to a pillar-like pin of a press-fit terminal and has spring characteristics, the contact part including:

a first retention contact piece that comes into contact with a connection target of the press-fit terminal and that includes a first retention part to be retained on the connection target; and

a coupling part that supports the first retention contact piece.

The first retention contact piece may include a straight portion being parallel to a central axis of the pin.

The contact part may include a first resilient contact piece that comes into contact with the connection target of the press-fit terminal,

the coupling part may support the first resilient contact piece, and

the first resilient contact piece may include a V-shaped portion that includes: a first slope portion that extends from the coupling part while being sloped relative to the central axis of the pin; and a second slope portion that bends at, and extends from, an end of the first slope portion.

The coupling part may include: a first support portion supporting the first retention contact piece; and a second support portion supporting the first resilient contact piece, and

the first support portion and the second support portion respectively have a first length and a second length in a direction of the central axis of the pin, the first length being shorter than the second length.

The contact part may include:

a second retention contact piece that comes into contact with the connection target of the press-fit terminal, that includes a second retention part to be retained on the connection target, and that is opposed to the first retention contact piece; and

a second resilient contact piece that comes into contact with the connection target of the press-fit terminal and that is opposed to the first resilient contact piece.

The second retention contact piece may include a portion being parallel to the central axis of the pin.

The coupling part may support the second resilient contact piece, and

the second resilient contact piece may include a V-shaped portion that includes: a third slope portion that extends from the coupling part while being sloped relative to the central axis of the pin; and a fourth slope portion that bends at, and extends from, an end of the third slope portion.

The coupling part may include a C-shaped cross section orthogonal to the central axis of the pin.

A press-fit terminal according to a second aspect of the present disclosure includes:

the contact part according to the first aspect; and

a pillar-like pin to which the contact part is connected.

The press-fit terminal may be inserted into a hole formed in the connection target, and

the first retention part may be retained on the connection target in a come-off preventing direction against an insertion direction toward the hole.

The contact part and the pin may be formed of different members.

The contact part and the pin may be formed of a single member.

The contact part according to the present disclosure includes a first retention contact piece that includes a first retention part to be retained on the connection target of the press-fit terminal. Owing to a retaining action provided by the first retention part, the press-fit terminal can have a greater retention force for the connection target.

### BRIEF DESCRIPTION OF THE DRAWINGS

A more complete understanding of this application can be obtained when the following detailed description is considered in conjunction with the following drawings, in which:

FIG. 1 is a perspective view of a press-fit terminal according to Embodiment 1 of the present disclosure;

FIG. 2 is a plan view of the press-fit terminal;

FIG. 3 is a cross-sectional view taken along in FIG. 2;

FIG. 4 is a partial enlarged view of FIG. 3;

FIG. 5 is a perspective view of a contact part and others;

FIG. 6 is a plan view of the contact part;

FIG. 7 is a cross-sectional view taken along VII-VII in FIG. 6;

FIG. 8 is a cross-sectional view taken along VIII-VIII in FIG. 6;

FIG. 9A is a perspective view of a lower coupling part;

FIG. 9B is a cross-sectional view of the lower coupling part;

FIG. 10 is a perspective view of the contact part spread open;

FIG. 11 is a front view of the contact part spread open;

FIG. 12A is a cross-sectional view (part 1) intended to explain actions of a retention contact part;

FIG. 12B is a cross-sectional view (part 2) intended to explain actions of the retention contact part;

FIG. 13 is a perspective view of a press-fit terminal according to a first comparative example;

FIG. 14 is a cross-sectional view of the press-fit terminal according to the first comparative example;

FIG. 15 is a cross-sectional view of a contact part according to a second comparative example;

FIG. 16A is a perspective view (part 1) of a press-fit terminal according to Embodiment 2 of the present disclosure;

FIG. 16B is a perspective view (part 2) of the press-fit terminal according to Embodiment 2; and

FIG. 17 is a cross-sectional view of the press-fit terminal according to Embodiment 2.

### DETAILED DESCRIPTION

### Embodiment 1

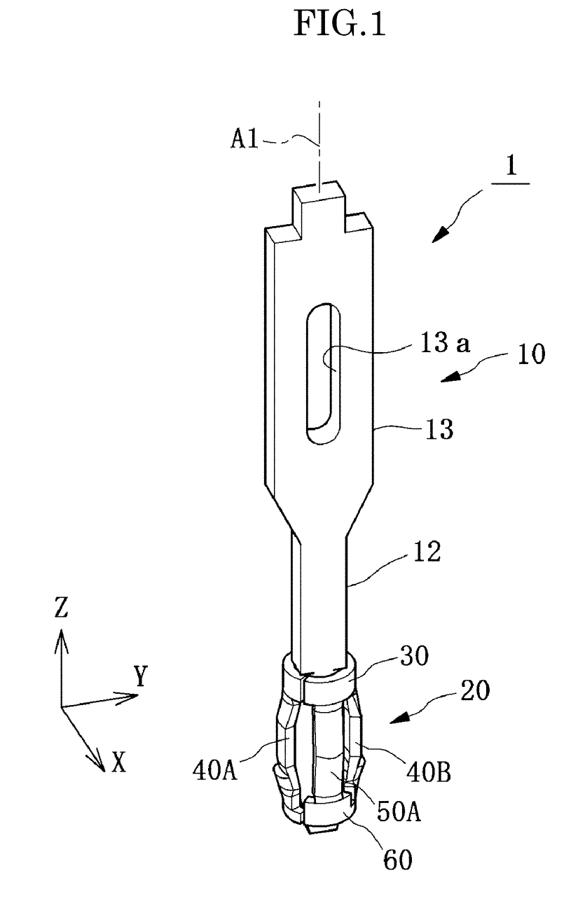

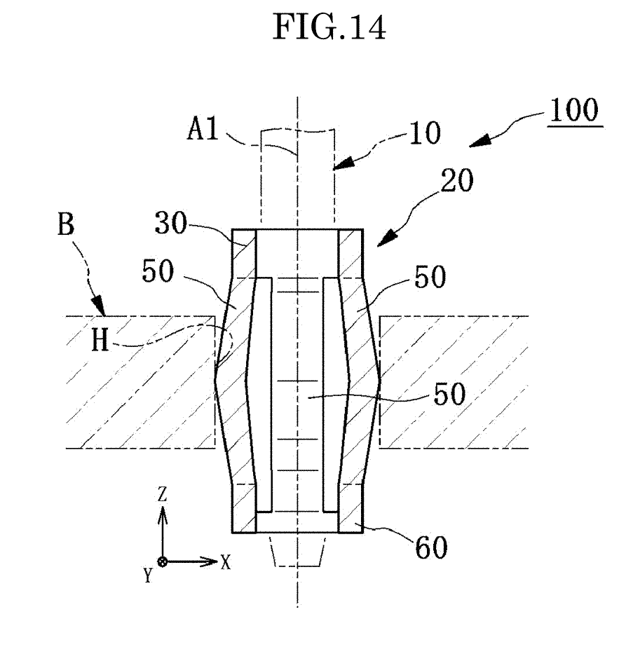

A press-fit terminal 1 and a contact part 20 according to Embodiment 1 of the present disclosure will now be described with reference to FIGS. 1 to 15. For ease of understanding, XYZ coordinates are used in the figures and referred to as appropriate, where the Z-axis direction is parallel to the central axis A1 of a pin 10 of the press-fit terminal 1. Identical reference symbols are given to identical or equivalent parts throughout the drawings.

The press-fit terminal 1 may be, for example, a terminal capable of carrying a large current of 60 A to 80 A, and becomes operational when, for example, electrically connected to a conductor portion of a circuit board B, which is the connection target of the press-fit terminal 1. As illustrated in FIG. 1, the press-fit terminal 1 includes the pin 10 and the contact part 20 having spring characteristics. In Embodiment 1, the pin 10 and the contact part 20 are formed of different members.

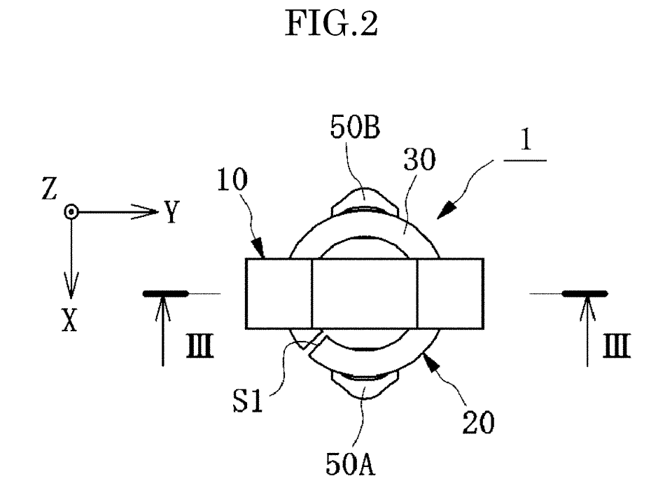

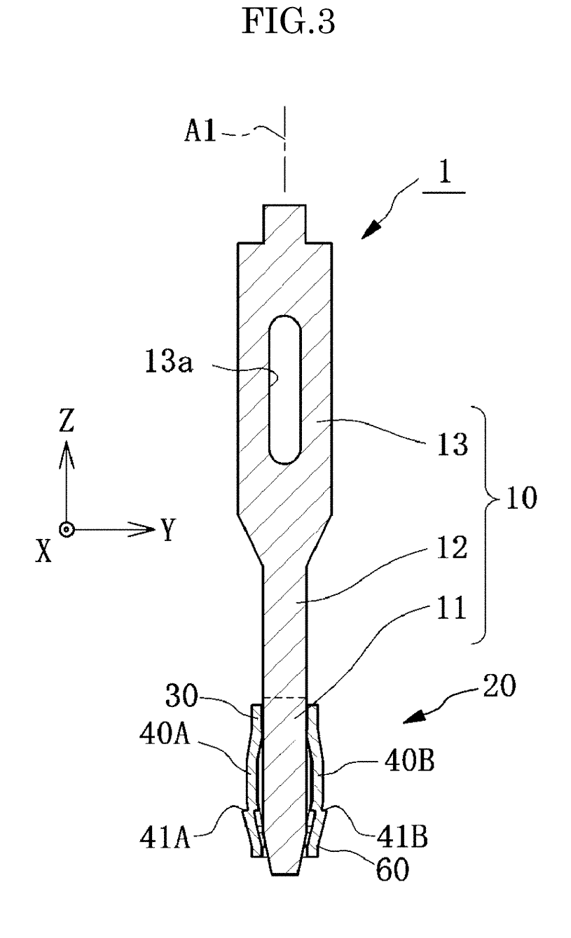

As illustrated in FIGS. 2 and 3, the pin 10 is a pillar-like member to which the contact part 20 is attached, and functions as a terminal for external connection for a terminal module (not illustrated). The pin 10 is formed by bending a plate material that is electrically conductive. The pin 10 includes a pin body 11 formed into a cylindrical shape, a main piece 12 formed into a plate strip, and a wide piece 13 having a portion wider than the main piece 12. In the wide piece 13 is formed an elongated hole 13a, which is drilled through the wide piece 13 in the X-axis direction and whose longitudinal direction corresponds to the Z-axis direction. A metal wire, for example, is bonded to the wide piece 13.

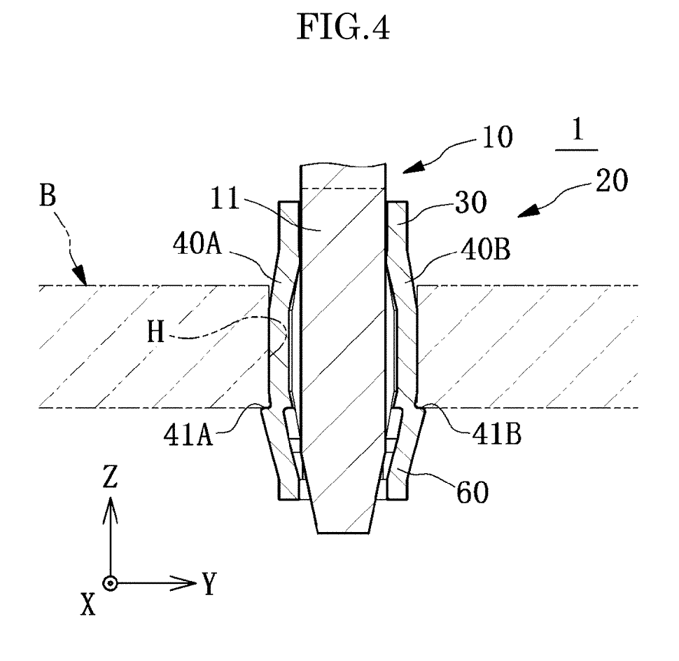

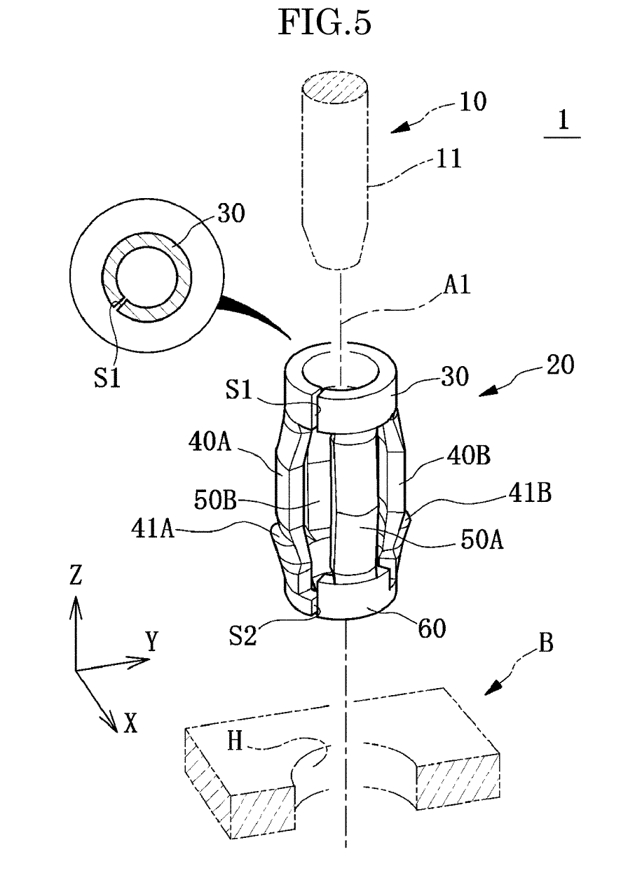

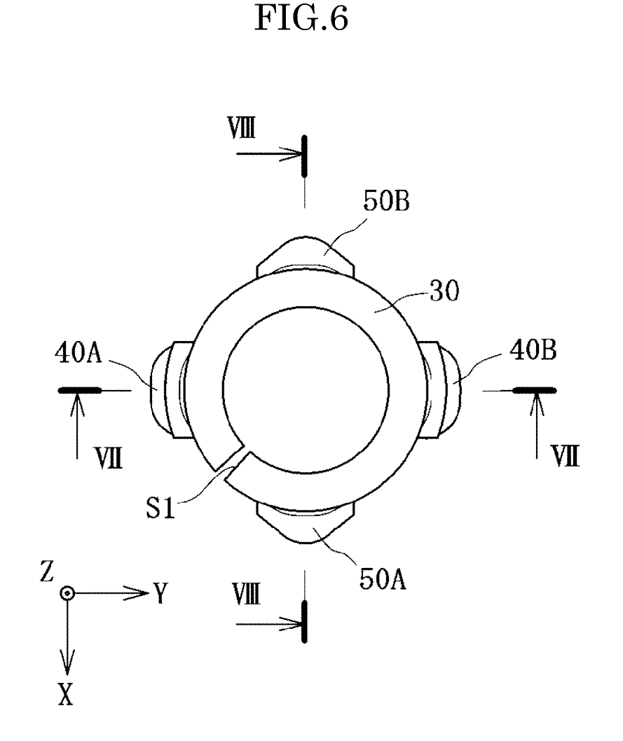

As illustrated in FIG. 4, the contact part 20 is formed into a substantially cylindrical shape having a through hole, and is fitted to the pin body 11 of the pin 10 from the lower side (in the +Z direction). As illustrated in FIGS. 5 and 6, the contact part 20 includes an upper coupling part 30, a pair of retention contact pieces 40A and 40B, a pair of resilient contact pieces 50A and 50B, and a lower coupling part 60.

The upper coupling part 30 is coupled to top ends (the ends on the +Z side) of the retention contact pieces 40A and 40B and to top ends (the ends on the +Z side) of the resilient contact pieces 50A and 50B to support both the retention contact pieces 40A and 40B and the resilient contact pieces 50A and 50B. The upper coupling part 30 is formed into a partially open C shape on an XY cross section of the upper coupling part 30. The open portion in the C-shaped upper coupling part 30 is formed to be a slit 51 leading from the inside to the outside. In Embodiment 1, one slit 51 is formed in the upper coupling part 30.

As illustrated in FIGS. 4 and 5, four contact pieces in total, namely the retention contact pieces 40A and 40B and the resilient contact pieces 50A and 50B, are to come into contact with an inner wall surface of a through hole H in the circuit board B, which is the connection target. Each of the retention contact pieces 40A and 40B and the resilient contact pieces 50A and 50B is formed to expand outward from the central axis A1 of the pin 10, and is disposed so as to deform inward when the press-fit terminal 1 is being inserted into the through hole H.

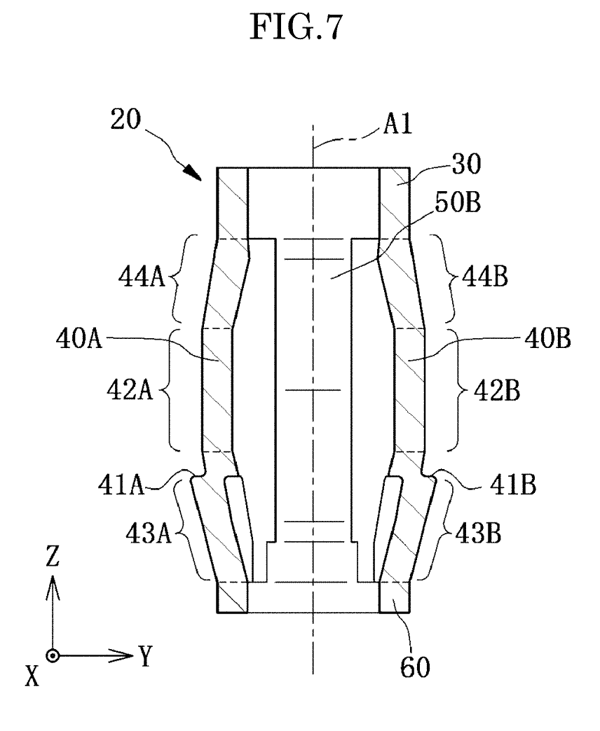

As illustrated in FIG. 7, the retention contact piece 40A (first retention contact piece) includes a first retention part 41A, a straight portion 42A, and slope portions 43A and 44A. The first retention part 41A is also used to be retained on the circuit board B, which is the connection target. The straight portion 42A is formed to be parallel to the Z-axis direction. Under the straight portion 42A (on the −Z side), the first retention part 41A is disposed. The slope portion 43A extends from the lower coupling part 60, being sloped away from the central axis A1 of the pin 10. The slope portion 44A bends at, and extends from, the end of the straight portion 42A on the +Z side while being sloped closer to the central axis A1 of the pin 10, and is coupled to the upper coupling part 30. These portions are arranged in the order of the slope portion 44A, the straight portion 42A, the first retention part 41A, and the slope portion 43A.

The retention contact piece 40B (second retention contact piece) is formed to be symmetrical with the retention contact piece 40A with respect to an XZ plane. As with the retention contact piece 40A, the retention contact piece 40B includes a second retention part 41B, a straight portion 42B, and slope portions 43B and 44B. With the first retention part 41A, the second retention part 41B is also used to be retained on the circuit board B, which is the connection target. The straight portion 42B is formed to be parallel to the Z-axis direction. Under the straight portion 42B (on the −Z side), the second retention part 41B is disposed. The slope portion 43B extends from the lower coupling part 60, being sloped away from the central axis A1 of the pin 10. The slope portion 44B bends at, and extends from, the end of the straight portion 42B on the +Z side while being sloped closer to the central axis A1 of the pin 10, and is coupled to the upper coupling part 30. These portions are arranged in the order of the slope portion 44B, the straight portion 42B, the second retention part 41B, and the slope portion 43B.

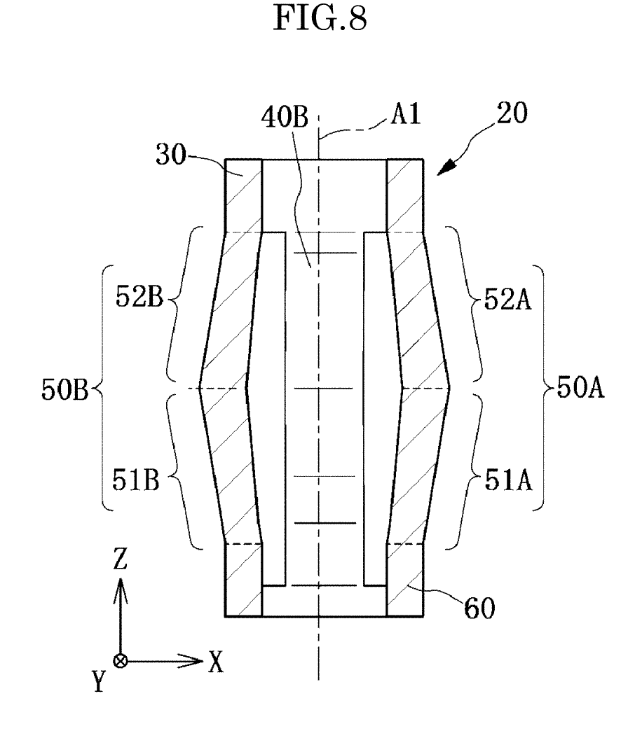

As illustrated in FIG. 8, the resilient contact piece 50A (first resilient contact piece) includes a first slope portion 51A and a second slope portion 52A. The first slope portion 51A extends from the lower coupling part 60, being sloped away from the central axis A1 of the pin 10. The second slope portion 52A bends at, and extends from, an end of the first slope portion 51A while being sloped closer to the central axis A1 of the pin 10, and is coupled to the upper coupling part 30. The first and second slope portions 51A and 52A together form a V shape.

The resilient contact piece 50B (second resilient contact piece) is formed to be symmetrical with the resilient contact piece 50A with respect to a YZ plane. As with the resilient contact piece 50A, the resilient contact piece 50B includes a third slope portion 51B and a fourth slope portion 52B. The third slope portion 51B extends from the lower coupling part 60, being sloped away from the central axis A1 of the pin 10. The fourth slope portion 52B bends at, and extends from, the end of the third slope portion 51B while being sloped closer to the central axis A1 of the pin 10, and is coupled to the upper coupling part 30. The third and fourth slope portions 51B and 52B together form a V shape.

As illustrated in FIG. 5, the lower coupling part 60 (coupling part) is coupled to bottom ends (the ends on the −Z side) of the retention contact pieces 40A and 40B and to bottom ends (the ends on the −Z side) of the resilient contact pieces 50A and 50B, so that the four contact pieces are supported by the upper and lower coupling parts 30 and 60. The lower coupling part 60 is formed into a partially open C shape on an XY cross section of the lower coupling part 60. The open portion in the C-shaped lower coupling part 60 is formed to be a slit S2 leading from the inside to the outside. In Embodiment 1, one slit S2 is formed in the lower coupling part 60.

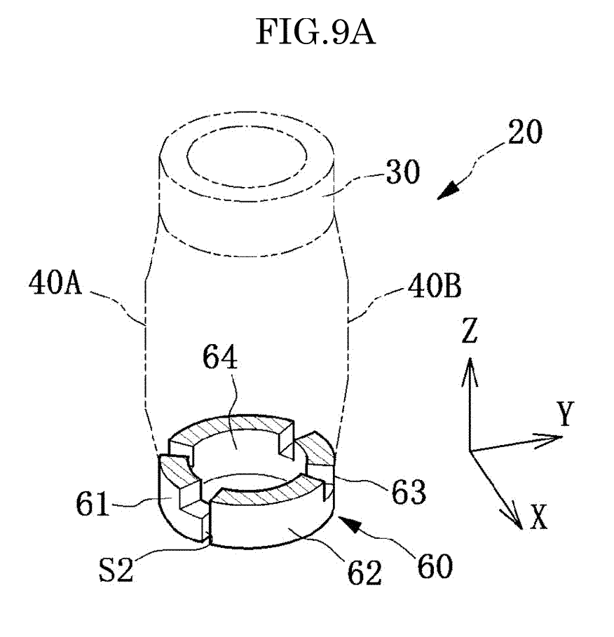

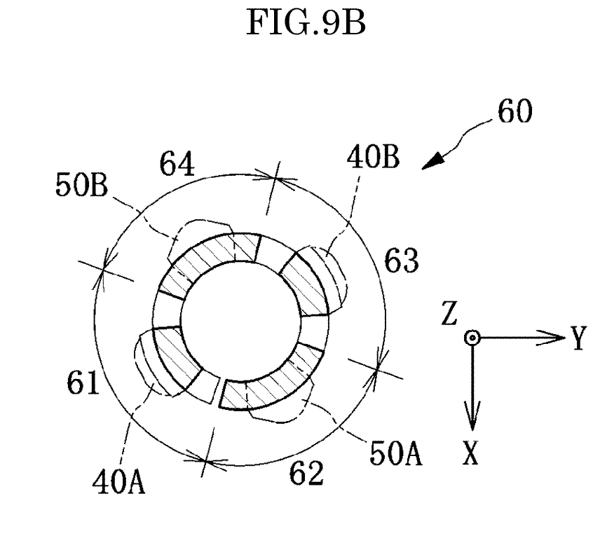

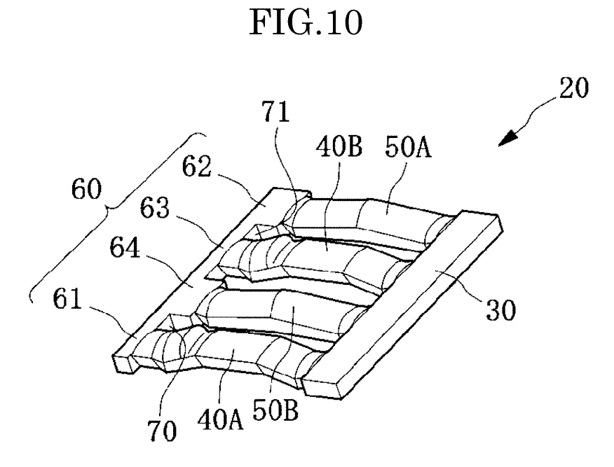

As illustrated in FIGS. 9A, 9B, and 10, the lower coupling part 60 includes four portions in total: a first support portion 61, a second support portion 62, a third support portion 63, and a fourth support portion 64. The first support portion 61, the second support portion 62, the third support portion 63, and the fourth support portion 64 are formed along a circumferential direction around the lower coupling part 60 in the order mentioned. The first support portion 61 supports the retention contact piece 40A, while the second support portion 62 supports the resilient contact piece 50A. The third support portion 63 supports the retention contact piece 40B, while the fourth support portion 64 supports the resilient contact piece 50B.

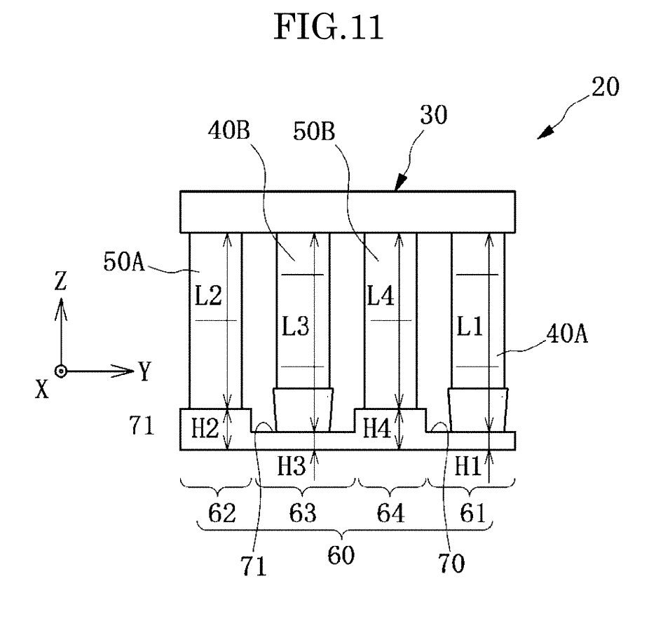

As illustrated in FIG. 11, the first support portion 61 in the lower coupling part 60 is formed so that the length H1 (first length) of the first support portion 61 along the Z-axis direction is equal to the length H3 of the third support portion 63 along the Z-axis direction. The second support portion 62 is formed so that its length H2 (second length) along the Z-axis direction is equal to the length H4 of the fourth support portion 64 along the Z-axis direction. In addition, the first and third support portions 61 and 63 are formed so that their respective lengths H1 and H3 along the Z-axis direction are shorter than the lengths H2 and H4 of the second and fourth support portions 62 and 64 along the Z-axis direction. Because the lengths H1 and H3 are shorter than the lengths H2 and H4, two cutouts 70 and 71 are made in the lower coupling part 60. The retention contact piece 40A is coupled to the lower coupling part 60 so as to extend from the bottom of the cutout 70. Likewise, the retention contact piece 40B is coupled to the lower coupling part 60 so as to extend from the bottom of the cutout 71.

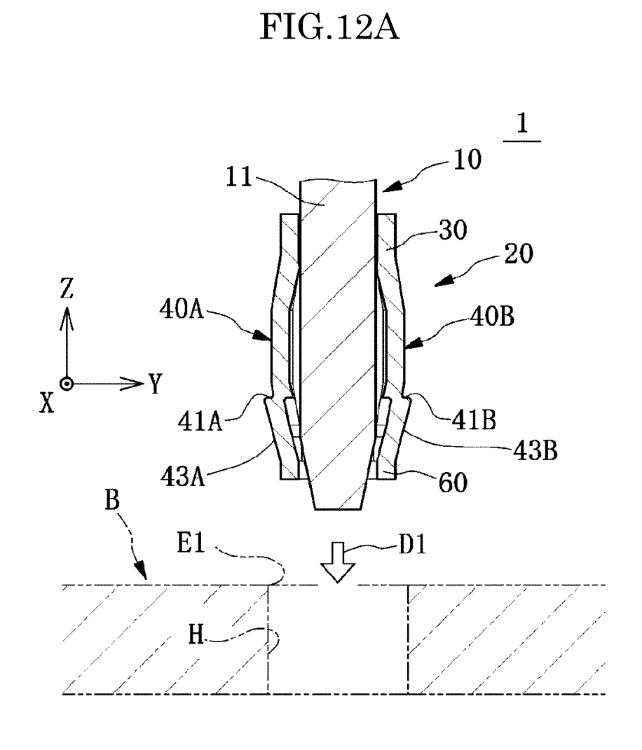

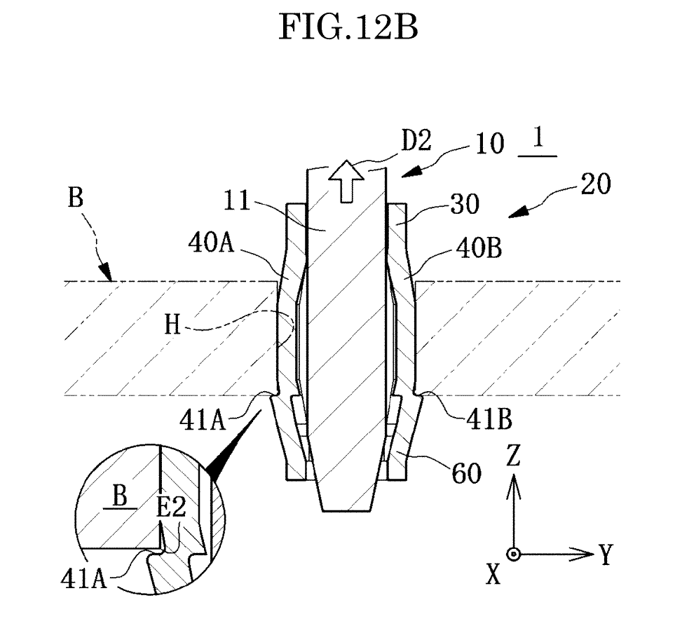

Referring to FIGS. 12A and 12B, the following describes actions of the contact part 20 provided when the press-fit terminal 1 configured as above is inserted into the through hole H in the circuit board B.

When the press-fit terminal 1 is moved in the insertion direction D1, as illustrated in FIG. 12A, the contact part 20 is inserted into the through hole H, and then the slope portions 43A and 43B come into contact with an upper edge E1 of an opening of the through hole H. When the contact part 20 is further inserted into the through hole H, the slope portions 43A and 43B are guided by the upper edge E1 of the opening, which causes the retention contact pieces 40A and 40B to deform inward. Then, as illustrated in FIG. 12B, the first retention part 41A and the second retention part 41B pass through the through hole H and are retained on a lower edge E2 of the opening of the through hole H. As a result, the first retention part 41A and the second retention part 41B are retained on the board in a come-off preventing direction D2 against the insertion direction D1 toward the through hole H.

As described above, in Embodiment 1, the retention contact pieces 40A and 40B include the first retention part 41A and the second retention part 41B, respectively, that are retained on the circuit board B. The first and second retention parts 41A and 41B are retained on the lower edge E2 of the opening of the through hole H, and thus the press-fit terminal 1 can have a greater retention force for the circuit board B.

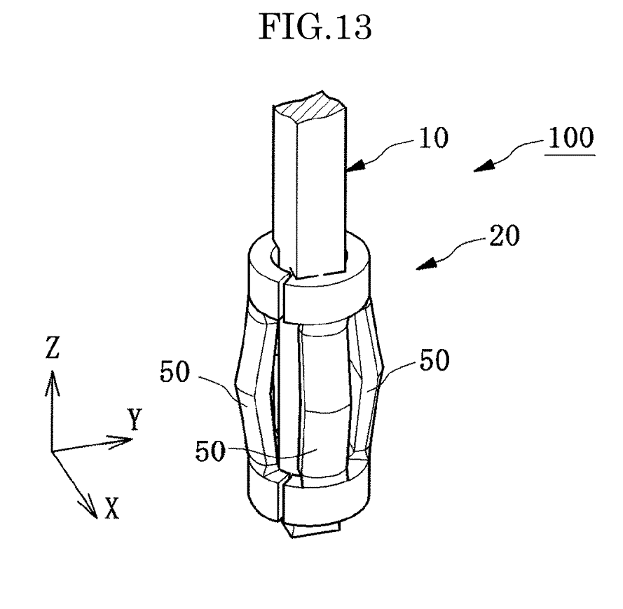

An example conventional press-fit terminal 100, which is shown in FIG. 13, has four contact pieces consisting of resilient contact pieces 50, but does not have any of the first and second retention parts 41A and 41B. Thus, the press-fit terminal 100 is retained on the circuit board B with a retention force obtained only from contact pressures on the resilient contact pieces 50.

In contrast, as illustrated in FIGS. 12A and 12B, the press-fit terminal 1 according to Embodiment 1 includes the retention contact pieces 40A and 40B that include the first retention part 41A and the second retention part 41B, respectively, and thus the first and second retention parts 41A and 41B are allowed to be retained on the lower edge E2 of the opening of the through hole H. As a result, the press-fit terminal 1 can have a greater retention force for the circuit board B.

In Embodiment 1, the retention contact pieces 40A and 40B include the straight portions 42A and 42B, respectively, as illustrated in FIG. 7. This enhances the ability of the first and second retention parts 41A and 41B to be retained on the lower edge E2 of the opening of the through hole H.

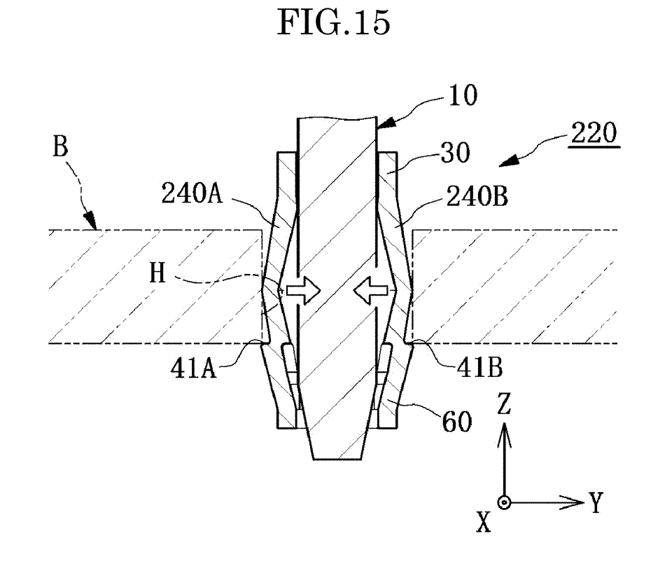

For example, in the case of a contact part 220 illustrated in FIG. 15, which includes substantially V-shaped retention contact pieces 240A and 240B but does not include any of the straight portions 42A and 42B, each of the convex portions of the V-shaped parts comes into contact with an inner wall of the through hole H. Thus, the retention contact pieces 240A and 240B may deform inward as indicated by arrows, and eventually the first and second retention parts 41A and 41B may be inadequately retained on the lower edge E2.

In contrast, the retention contact pieces 40A and 40B according to Embodiment 1 can be securely retained on the lower edge E2 of the opening of the through hole H, as illustrated in FIGS. 12A and 12B. As a result, the press-fit terminal 1 can have a greater retention force for the circuit board B.

In addition, as seen in FIG. 8, the press-fit terminal 1 according to Embodiment 1 includes not only the retention contact pieces 40A and 40B but also the resilient contact pieces 50A and 50B that are partially V-shaped like conventional shapes. The V-shaped convex portions of these resilient contact pieces 50A and 50B come into contact with an inner wall of the through hole H, and thus a high contact pressure is obtained to enhance the ability to make an electrical connection. Therefore, Embodiment 1 allows the retention contact pieces 40A and 40B to be securely retained on the lower edge E2 of the opening of the through hole H, and at the same time, the ability equivalent to that of the conventional press-fit terminal 100 to make an electrical connection is maintained.

Moreover, in Embodiment 1, the retention contact pieces 40A and 40B extend from the bottoms of the cutouts 70 and 71, respectively, as illustrated in FIGS. 10 and 11. That is, the retention contact pieces 40A and 40B are formed so that their respective lengths L1 and L3 are longer than the lengths L2 and L4 of the resilient contact pieces 50A and 50B. Thus, the retention contact pieces 40A and 40B each have a longer spring portion, and accordingly a greater amount of deformation can be obtained. As a result, the retention contact pieces 40A and 40B are prevented from undergoing fatigue or degradation of spring properties, and eventually impairment of the retaining ability of the retention contact pieces 40A and 40B attributable to such fatigue or degradation can be prevented.

Furthermore, because the retention contact pieces 40A and 40B can have a greater amount of deformation, the insertion force for inserting the press-fit terminal 1 into the through hole H can be reduced. The reduced insertion force leads to preventing damages to the board and removal of the plating applied on the retention contact pieces 40A and 40B that may be caused when the press-fit terminal 1 is inserted into the through hole H.

### Embodiment 2

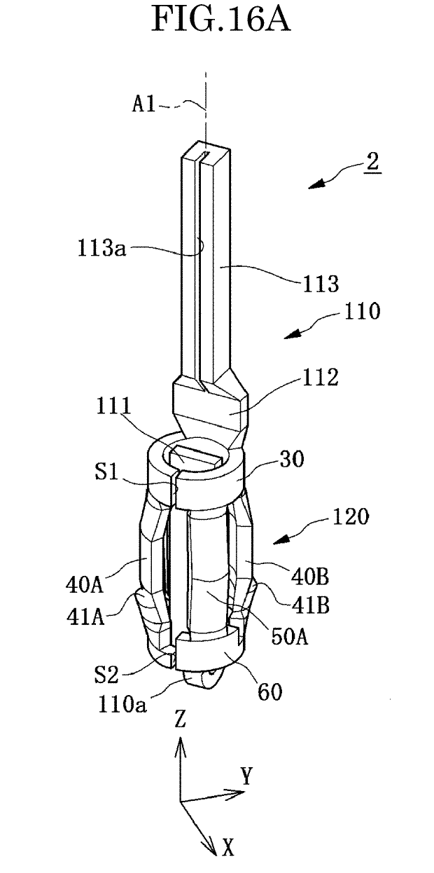

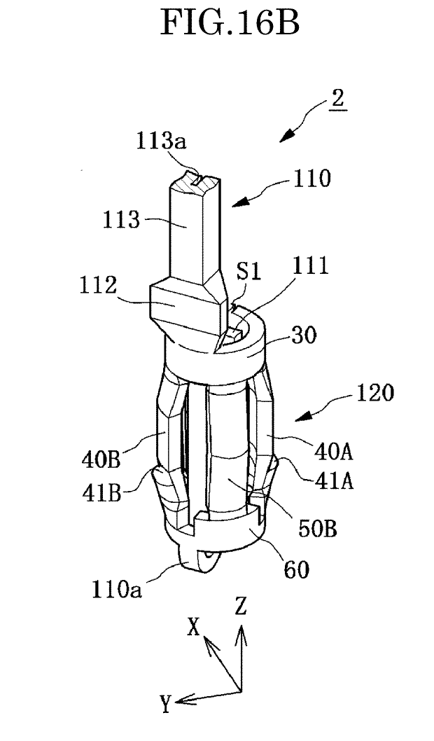

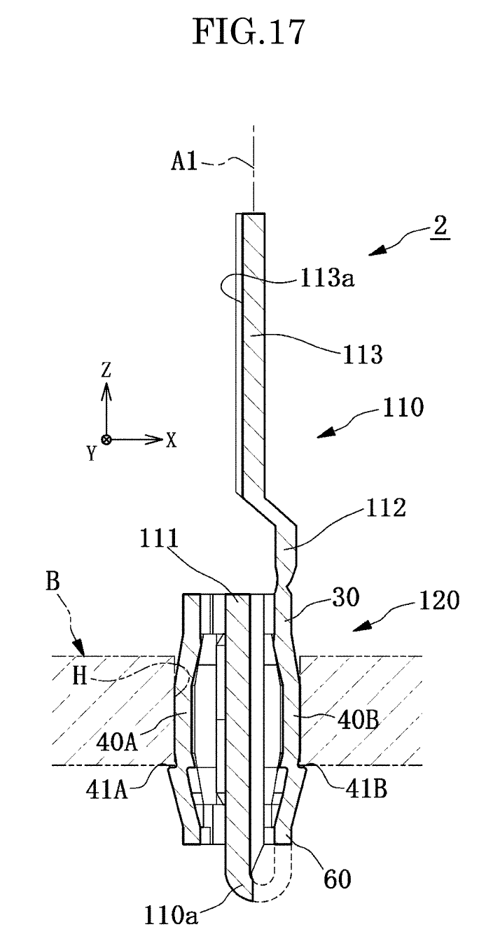

A press-fit terminal 2 according to Embodiment 2 of the present disclosure will now be described with reference to FIGS. 16 and 17. For ease of understanding, the description about Embodiment 2 below focuses on differences from Embodiment 1, while giving identical symbols to components in common with Embodiment 1 and omitting their descriptions.

As illustrated in FIG. 16, the press-fit terminal 2 includes a pin 110 and a contact part 120 having spring characteristics. The press-fit terminal 2 according to Embodiment 2 is different from the press-fit terminal 1 of Embodiment 1 in that the pin 110 and the contact part 120 are formed of a single member. The pin 110 and the contact part 120 are formed by bending a single plate material that is electrically conductive.

The contact part 120 is formed into a shape similar to that of the contact part 20 according to Embodiment 1. Specifically, the contact part 120 includes an upper coupling part 30, a pair of retention contact pieces 40A and 40B, a pair of resilient contact pieces 50A and 50B, and a lower coupling part 60. The retention contact piece 40A includes a first retention part 41A, while the retention contact piece 40B includes a second retention part 41B.

The pin 110 includes a pin body 111, a bend 110a, a main piece 112, and a narrow piece 113.

As illustrated in FIG. 17, the pin body 111 is formed into a rectangular pillar. The pin body 111 is placed in parallel to the Z-axis direction inside the contact part 120.

The bend 110a extends from the bottom end (the end on the −Z side) of the lower coupling part 60 in the contact part 120, bends upward (to the +Z side), and is connected to the bottom end of the pin body 111.

The main piece 112 extends from the top end (the end on the +Z side) of the upper coupling part 30 in the contact part 120. The main piece 112 is formed into a plate.

The narrow piece 113, which includes a portion narrower than the main piece 112 as illustrated in FIG. 16, extends from the top end (the end on the +Z side) of the main piece 112. A groove 113a is formed in the narrow piece 113 along the Z-axis direction. A metal wire, for example, is bonded to the narrow piece 113.

As in Embodiment 1, the press-fit terminal 2 according to Embodiment 2 configured as above has the retention contact pieces 40A and 40B that include the first retention part 41A and the second retention part 41B, respectively, that are retained on the circuit board B. The first and second retention parts 41A and 41B are retained on the lower edge E2 of the opening of the through hole H, and thus the press-fit terminal 2 can have a greater retention force for the circuit board B. Other effects equivalent to those of the foregoing press-fit terminal 1 can also be obtained.

In Embodiment 2, the pin 110 and the contact part 120 are formed by bending a single plate material that is electrically conductive. Thus, the steps of producing the pin 110 and the contact part 120 separately and assembling the pin 110 and the contact part 120 into a press-fit terminal are unnecessary. As a result, work man-hours can be reduced.

Embodiments of the present disclosure have been described above, but the present disclosure is not limited to the foregoing embodiments.

For example, in Embodiments 1 and 2 of the present disclosure, the press-fit terminals 1 and 2 each include four contact pieces in total: a pair of retention contact pieces 40A and 40B and a pair of resilient contact pieces 50A and 50B. However, the press-fit terminal may include any number of retention contact pieces 40A, 40B and any number of resilient contact pieces 50A, 50B. The number of contact pieces included in the press-fit terminal 1 or 2 is not limited to the number illustrated in Embodiments 1 and 2. For example, the press-fit terminals 1 and 2 each may include three retention contact pieces and three resilient contact pieces. Alternatively, all the contact pieces included in the press-fit terminal 1 or 2 may be retention contact pieces.

The foregoing describes some example embodiments for explanatory purposes.

Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

What is claimed is:

1. A contact part connected to a pillar-like pin of a press-fit terminal and having spring characteristics, the contact part comprising:
a first retention contact piece that comes into contact with a connection target of the press-fit terminal and that includes a first retention part to be retained on the connection target; and
a coupling part that supports the first retention contact piece.

2. The contact part according to claim 1, wherein the first retention contact piece includes a straight portion being parallel to a central axis of the pin.

3. The contact part according to claim 1, further comprising:
a first resilient contact piece that comes into contact with the connection target of the press-fit terminal,
wherein the coupling part further supports the first resilient contact piece, and
wherein the first resilient contact piece includes a V-shaped portion that comprises: a first slope portion that extends from the coupling part while being sloped relative to the central axis of the pin; and a second slope portion that bends at, and extends from, an end of the first slope portion.

4. The contact part according to claim 3, wherein
the coupling part comprises: a first support portion supporting the first retention contact piece; and a second support portion supporting the first resilient contact piece, and
the first support portion and the second support portion respectively have a first length and a second length in a direction of the central axis of the pin, the first length being shorter than the second length.

5. The contact part according to claim 3, further comprising:
a second retention contact piece that comes into contact with the connection target of the press-fit terminal, that includes a second retention part to be retained on the connection target, and that is opposed to the first retention contact piece; and
a second resilient contact piece that comes into contact with the connection target of the press-fit terminal and that is opposed to the first resilient contact piece.

6. The contact part according to claim 5, wherein the second retention contact piece includes a portion being parallel to the central axis of the pin.

7. The contact part according to claim 5, wherein
the coupling part supports the second resilient contact piece, and
the second resilient contact piece includes a V-shaped portion that comprises: a third slope portion that extends from the coupling part while being sloped relative to the central axis of the pin; and a fourth slope portion that bends at, and extends from, an end of the third slope portion.

8. The contact part according to claim 1, wherein the coupling part includes a C-shaped cross section orthogonal to the central axis of the pin.

9. A press-fit terminal comprising:
a contact part connected to a pillar-like pin of the press-fit terminal and having spring characteristics, the contact part including: a first retention contact piece that comes into contact with a connection target of the press-fit terminal and that includes a first retention part to be retained on the connection target; and a coupling part that supports the first retention contact piece; and
a pillar-like pin to which the contact part is connected.

10. The press-fit terminal according to claim 9, wherein
the press-fit terminal is to be inserted into a hole formed in the connection target, and
the first retention part is retained on the connection target in a come-off preventing direction against an insertion direction toward the hole.

11. The press-fit terminal according to claim 9, wherein the contact part and the pin are formed of different members.

12. The press-fit terminal according to claim 9, wherein the contact part and the pin are formed of a single member.

13. The press-fit terminal according to claim 9,
wherein the first retention contact piece includes a straight portion being parallel to a central axis of the pin.

14. The press-fit terminal according to claim 9, further comprising:
a first resilient contact piece that comes into contact with the connection target of the press-fit terminal,
wherein the coupling part further supports the first resilient contact piece, and
wherein the first resilient contact piece includes a V-shaped portion that comprises: a first slope portion that extends from the coupling part while being sloped relative to the central axis of the pin; and a second slope portion that bends at, and extends from, an end of the first slope portion.

15. The press-fit terminal according to claim 14, wherein
the coupling part comprises: a first support portion supporting the first retention contact piece; and a second support portion supporting the first resilient contact piece, and
the first support portion and the second support portion respectively have a first length and a second length in a direction of the central axis of the pin, the first length being shorter than the second length.

16. The press-fit terminal according to claim 14, further comprising:
a second retention contact piece that comes into contact with the connection target of the press-fit terminal, that includes a second retention part to be retained on the connection target, and that is opposed to the first retention contact piece; and
a second resilient contact piece that comes into contact with the connection target of the press-fit terminal and that is opposed to the first resilient contact piece.

17. The press-fit terminal according to claim 16, wherein the second retention contact piece includes a portion being parallel to the central axis of the pin.

18. The press-fit terminal according to claim 16, wherein
the coupling part supports the second resilient contact piece, and
the second resilient contact piece includes a V-shaped portion that comprises: a third slope portion that extends from the coupling part while being sloped relative to the central axis of the pin; and a fourth slope portion that bends at, and extends from, an end of the third slope portion.

19. The press-fit terminal according to claim 9, wherein the coupling part includes a C-shaped cross section orthogonal to the central axis of the pin.
